(19) United States
(12) Patent Application Publication
(10) Pub. No.: US 2008/0276775 A1
(43) Pub. Date: Nov. 13, 2008

(54) Endless blade trim saw for trimming lumber workpieces and methods

(75) Inventors: Keith Hewitt, Sandy, OR (US); Brett Crowe, Portland, OR (US); Bruce Whyte, Shannonville (CA)

Correspondence Address: KLARQUIST SPARKMAN, LLP, 121 SW SALMON STREET, SUITE 1600, PORTLAND, OR, 97204, US

(73) Assignee: L-M Equipment Company, Inc

(21) Appl. No.: 11/801,025

(22) Filed: May 7, 2007

(51) Int. Cl. B26D 1/54

(52) U.S. Cl. 83/56; 83/810

(57) ABSTRACT

Described herein are several embodiments of a trim saw for trimming lumber work pieces. For example, in one exemplary embodiment, a reduced waste single column trim saw for cutting a workpiece having multiple aligned workpiece components that are assembled together can include a frame member, an endless band saw blade, and first and second blade turning regions. The frame member can include at least one driving wheel and at least one driven wheel. The endless band saw blade can extend about and be movably retained by the at least one driving wheel and at least one driven wheel such the endless band saw blade is horizontally drivable through a workpiece cutting region. The trim saw can include a first blade turning region proximate a first end of the workpiece cutting region and a second blade turning region proximate a second end of the workpiece cutting region. The blade can be turned approximately ninety degrees in the first blade turning region and again turned approximately ninety degrees in the second blade turning region.

### FIELD

The present disclosure relates to an apparatus for cutting materials and more specifically, to an endless blade trim saw for trimming lumber packs.

### BACKGROUND

Saws for cutting or trimming objects are well known in the art. Such saws can include, for example, band saws, circular saws and chain saws, and can be used to cut objects of any of various sizes in any of various applications.

In certain applications, for example, band saws are widely used to perform crosscut or split cut operations on wood, metal, plastics and other materials. Typical types of band saws include vertical, horizontal and pivoting band saws. Generally, a band saw includes a driving wheel and a driven wheel about which an endless band saw blade circulates with the blade oriented parallel to the axes of the wheels. However, depending on the type of cut desired, the band saw blade can be twisted or reoriented prior to cutting an object such that the object is cut with the blade at a predetermined angle.

In one type of conventional band saw, the axes of the driving and driven wheels are angled with respect to horizontal and the band saw blade is twisted less than ninety degrees such that the blade is in a vertical orientation prior to cutting an object. Such a configuration, however, can result in certain disadvantages. For example, angled wheels can reduce the space available for other components and restrict the size of the objects that can be positioned in an object receiving area of the band saw for cutting.

In one type of conventional band saw, a dual column approach is used. In other words, conventional band saws of this type include two spaced-apart, fixed guide columns each anchored to a base. The wheels are coupled to structures that move along the guide columns to raise and lower the band saw blade and the blade circulates between the fixed columns to make a cut. Such band saws are limited to receiving objects to be cut from sides of the band saw. In other words, with conventional band saws of this type, objects to be cut cannot be loaded from a front of the band saw, as one of the two fixed guide columns would prevent such loading.

In another type of conventional band saw, the band saw includes a pivotable arm to which the wheels and blade are attached. The arm is pivotable about an end to cut an object. Pivotable arm band saws can have several disadvantages, such as, for example, reduced controllability of the arm due to the pivot connection, increased strain on saw components and increased size due to the diagonal clearance requirements of the arm.

In many industrial applications, saws are used for cutting a substantial number of objects in a short amount of time. For example, in the lumber industry, small saws, such as portable yard saws, chop saws, band saws or deck saws can be used to quickly cut small bundles of lumber or small individual logs or boards, while larger saws, such as hydraulically powered chainsaw or horizontal/vertical band saw systems can be used to quickly cut large bundles of lumber or large individual logs. However, speed is only one factor in determining the desirability of a saw in an industrial application. Typically, saws that cut the highest number of objects in the shortest amount of time for the lowest operating cost are desired.

Generally, the lower the waste products resulting from a cut, the lower the operating cost. In the lumber cutting industry, waste typically is generated from one of two sources: (1) the amount of material from the object that is consumed due to the cut itself, e.g., sawdust, wood chips, dust, etc., and (2) trimmed end pieces that are too small for practical use or unrecoverable. Costs result from the time and labor associated with removing and disposing of the removed material and unusable trimmed end pieces, as well as the cost of the wasted material itself. Although costs associated from waste material per cut may be considered nominal, with the substantial number of cuts performed over time, costs can quickly accumulate.

For example, some conventional chainsaw systems for cutting lumber use chainsaw blades. Although chain saw blades may cut through material in a short amount of time, they often result in an increased amount of waste since the kerf from a chainsaw blade is substantial. In fact, the kerf of a conventional chainsaw chain may lead a user not to make a trim cut in many applications due to the resulting waste. Additionally, chainsaw systems may cut lumber with low accuracy, or tolerance, especially over time. Further, cuts performed by chainsaw systems are typically aggressive cuts often resulting in poor quality cuts.

Accordingly, it would be particularly advantageous to provide a trim saw that provides quick, high quality and accurate cuts while reducing waste thereby increasing lumber recovery.

In the lumber cutting industry, lumber is cut generally in one of two ways: lateral cross-cutting or longitudinal splitting. Typically, conventional trim saws used in lumber cutting applications are each configured to perform either cross-cutting operations or splitting operations, but not both. Therefore, it would be advantageous to provide a trim saw capable of performing both lateral cross-cutting and longitudinal splitting operations on lumber and other objects.

### SUMMARY

Described herein are several embodiments of a trim saw for trimming lumber work pieces.

For example, in one exemplary embodiment, a reduced waste single column trim saw for cutting a workpiece having multiple aligned workpiece components that are assembled together can include a frame member, an endless band saw blade, and first and second blade turning regions. The frame member can include at least one driving wheel and at least one driven wheel. The endless band saw blade can extend about and be movably retained by the at least one driving wheel and at least one driven wheel such the endless band saw blade is horizontally drivable through a workpiece cutting region. The at least one driving wheel and the at least one driven wheel can rotate about respective axes each approximately parallel to horizontal such that a cutting plane of the endless band saw blade prior to being driven through the workpiece cutting region is approximately parallel to the axis of the driving and driven wheels.

A first blade turning region can be proximate a first end of the workpiece cutting region and a second blade turning region can be proximate a second end of the workpiece cutting region. The endless band saw blade can be turned approximately ninety degrees in the first blade turning region prior to entering the workpiece cutting region such that the cutting plane of the band saw blade is approximately perpendicular to horizontal when driven through the workpiece cutting region. Further, the endless band saw blade can be turned approximately ninety degrees in the second blade turning region upon exiting the workpiece cutting region such that the cutting plane of the band saw blade is approximately parallel to horizontal.

In some implementations, the frame member can be raisable along the single column into an open position. In the open position, a workpiece can be loadable under the workpiece cutting region via one of a front, upstream side and downstream side of the horizontal support.

In some implementations, the frame member can include a first vertical member that is coupled to the column, a horizontal member that is coupled to and extends approximately transversely from the first vertical member, and a second vertical member. The second vertical member can (i) be coupled to the horizontal member at a first attached end; (ii) extend approximately transversely downwardly from the horizontal member; (iii) terminate at a second unattached end; and (iv) be spaced-apart from and extend approximately parallel to the first vertical member.

In certain implementations, the first blade turning region can include a first blade guide assembly coupled to the frame and the second blade turning region comprises a second blade guide assembly coupled to the frame, wherein the first and second blade guide assemblies engage and align the endless band saw blade.

In yet some implementations, the trim saw can provide a substantial reduction in cut-induced byproducts.

In another exemplary embodiment, an endless blade precision saw for cutting a lumber workpiece includes a workpiece support surface, an endless saw blade and an endless saw blade support. The workpiece support surface can be capable of receiving the lumber workpiece. The endless saw blade can be operatively positioned relative to and span one dimension of the workpiece support surface and be selectively positionable to cut the lumber workpiece. The endless saw blade support can include first and second spaced-apart portions that are positioned at opposite sides of the workpiece support surface. The first and second spaced-apart support portions can have respective wheel elements that rotatably support and selectively drive the saw blade and at least two blade guides. One of the first and second support portions can be cantilevered and have a first fixed end and a second open or cantilevered end. The support portions can be movable to move the endless saw blade into a raised position to allow the lumber workpiece to be positioned as desired on the workpiece support surface and to move the endless saw blade into a lowered position to contact and cut the lumber workpiece. The saw blade support can define an open working area within which the lumber workpiece can be received. The saw blade support can further include a cutting zone extending at least as long as a desired cut through the lumber workpiece. The trim saw can be operable in a first mode for cross-cutting lumber workpieces and a second mode for splitting lumber workpieces.

In some implementations, in the cross-cutting first mode, at least one blade guide can twist the blade from a horizontal orientation parallel to the workpiece support surface to a vertical orientation perpendicular to the work piece support surface prior to the blade entering the cutting zone. Further, at least one blade guide can twist the blade from the vertical orientation to the horizontal orientation after the blade exits the cutting zone.

In some implementations, the at least two blade guides can be capable of twisting the saw blade a substantial angle. In some implementations, in the splitting second mode, the at least two blade guides can maintain the blade in a horizontal orientation parallel to the workpiece support surface when the blade is in the cutting zone.

In some implementations, the endless saw blade support can be movable along the workpiece support surface. The precision saw can further include a carriage that is coupled to the endless saw blade support. The carriage can be capable of supporting an operator and movable with the endless saw blade support along the workpiece support surface.

In some implementations, the precision saw can further include a workpiece alignment stop that is coupled to the workpiece support surface. In yet some implementations, the saw blade path can be sized such that the open working area is a large capacity working area capable of receiving a lumber workpiece that has a height up to at least four feet and a width up to at least four feet.

In certain implementations, the workpiece support surface can include one or more generally horizontally oriented planar surfaces and the first and second spaced-apart support portions can be generally vertically oriented. In some implementations, a loaded workpiece can be cuttable by the endless saw blade without clamping the workpiece to the workpiece support surface. In yet some implementations, the blade can have a thickness of approximately 0.063 inches, or in some instances less than approximately 0.10 inches.

In yet other exemplary implementations, the endless blade precision saw can be operable in a third mode for vertically mitering lumber workpieces. In such implementations, the endless saw blade support can be rotatable about a vertical axis. In certain other implementations, the trim saw is operable in a fourth mode for angularly mitering lumber workpieces.

In another known embodiment, a method for cutting a workpiece using a horizontal band saw machine can include providing a horizontal band saw machine that has a single column construction. The band saw machine can include a single column that is positioned on a rear side of the band saw machine and a saw blade support arm that is movable along the single column. The band saw machine can define a workpiece loading region adjacent the single column. The method can further include feeding a workpiece into the workpiece loading region of the horizontal band saw machine and driving an endless band saw blade about the saw blade support arm in a horizontal orientation and through a workpiece cutting region. Also, the method can include cutting a workpiece positioned within the workpiece cutting region.

In some implementations, prior to the endless band saw blade entering the workpiece cutting region, the method can include turning the band saw blade approximately ninety degrees such that a cutting plane of the band saw blade is in a vertical orientation when driven through the workpiece cutting region.

In certain implementations, the method can further include raising the saw blade support arm and the workpiece cutting region above the workpiece loading region and lowering the saw blade support arm relative to the workpiece loading region to position the workpiece within the workpiece cutting region to cut the workpiece.

In some implementations, the endless band saw blade can be driven through the workpiece cutting region in the horizontal orientation. In specific implementations, feeding can include feeding the workpiece into the workpiece cutting region to cut the workpiece. In other specific implementations, the horizontal band saw machine can further include a movable carriage and the saw blade support arm, band saw blade and single column can be coupled to the movable carriage. The method can further include moving the movable carriage to position the workpiece within the workpiece cutting region to cut the workpiece.

In some implementations, feeding the workpiece can include feeding the workpiece via one of a front, upstream or downstream side of the band saw machine, the front side being generally opposite the rear side of the band saw machine.

In yet some implementations, the horizontal band saw machine can further include a movable carriage where saw blade support arm and single column are coupled to the movable carriage. The method can further include moving the movable carriage to move the saw blade support arm and single column relative to the workpiece loading region. In specific implementations, the method further includes moving the movable carriage to a position proximate an end portion of the workpiece, and lowering the band saw blade support arm to position the workpiece within the workpiece cutting region to cut the end portion off of the workpiece.

In one specific implementation, the position can include a first position and the end portion can include a first end portion. In this implementation, the method can further include moving the movable carriage from the first position proximate the first end portion of the workpiece to a second position intermediate the first end portion and a second end portion of the workpiece. The method can also include lowering the band saw blade support arm such that the driven band saw blade cuts through the workpiece at a location intermediate the first and second end portions of the workpiece.

In some implementations, the saw blade support arm can be lowered to cut the workpiece positioned in the workpiece loading region without clamping the workpiece.

It is also described that in some implementations, the single column can be rotatable about a vertical axis and the method can further comprise rotating the column. In such implementations, cutting the workpiece can comprise mitering the workpiece.

In yet other implementations, the endless band saw blade can be driven through the workpiece cutting region in an angular orientation intermediate the horizontal orientation and a vertical orientation. In such implementations, the method can further comprise vertically lowering the blade support arm and simultaneously horizontally moving the column to cut the workpiece positioned within the workpiece cutting region.

The foregoing and other features and advantages of the disclosed apparatus will become more apparent from the following detailed description, which proceeds with reference to the accompanying figures.

### BRIEF DESCRIPTION OF THE DRAWINGS

FIG. 1 is an isometric view of one exemplary embodiment of a trim saw.

FIG. 2 is a left side elevation view of the trim saw of FIG. 1.

FIG. 3 is a left side elevation view of the trim saw of FIG. 1 shown with a saw blade drive mechanism cover according to one particular implementation.

FIG. 4 is a right side elevation view of the trim saw of FIG. 1.

FIG. 5 is a top plan view of the trim saw of FIG. 1.

FIG. 6 is a right side elevation view of a saw blade drive mechanism of the trim saw of FIG. 1.

FIG. 7 is a right side detailed elevation view of first and second blade transition assemblies of the saw blade drive mechanism shown in FIG. 6.

FIG. 8 is a left side elevation view of the trim saw of FIG. 1 shown in an open or fully raised position.

FIG. 9 is a left side elevation view of the trim saw of FIG. 1 in a second splitting mode.

FIG. 10 is an isometric detailed view of a blade transition assembly according to one embodiment.

FIG. 11 is a top plan view of the trim saw of FIG. 1 shown in a miter cut mode.

### DETAILED DESCRIPTION

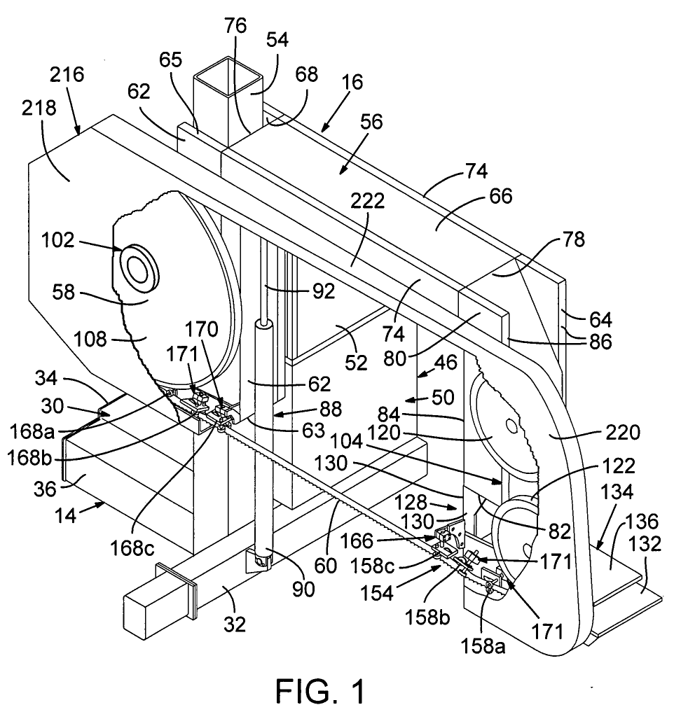

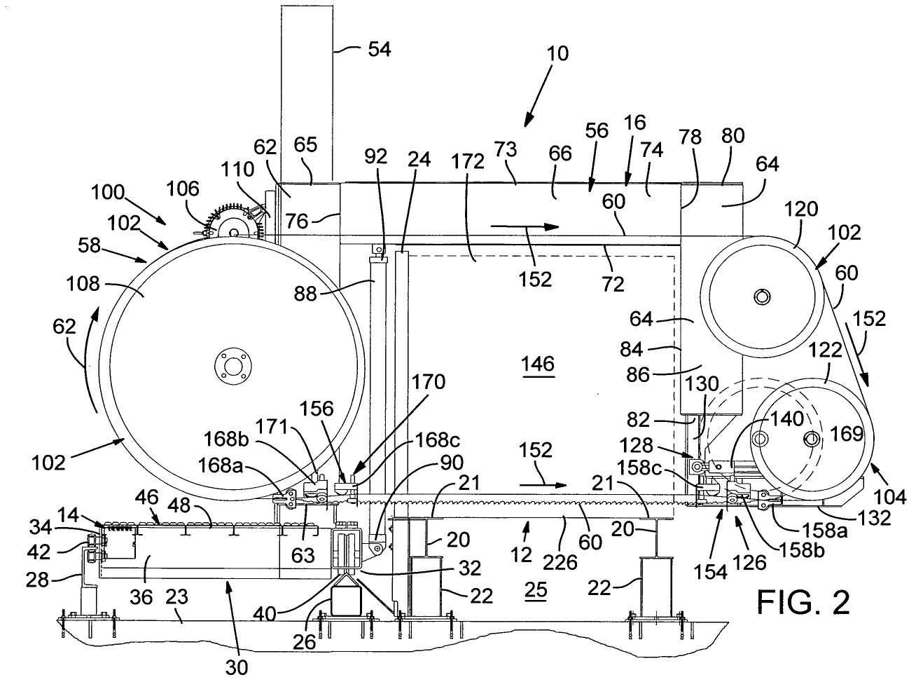

Referring to FIGS. 1-8, embodiments of a trim saw 10 for cutting objects or workpieces, such as lumber, are shown. The trim saw 10 includes a workpiece support portion 12 (see FIGS. 2-4), a carriage portion 14 and a workpiece cutting portion 16. Generally, the workpiece support portion 12 supports a workpiece to be cut by the workpiece cutting portion 16, which is movable along a length of the workpiece via the carriage portion 14.

More specifically, the workpiece support portion 12 supports a workpiece, such as workpiece 172, via rails, or beams, 20 in a horizontal orientation. More specifically, the support portion 12 includes two spaced-apart rails 20 each having substantially planar workpiece support surfaces 21 on which a workpiece can be supported. The rails 20 extend substantially parallel to each other in the longitudinal direction. In some implementations, the rails 20 are I-beams, such as shown in FIGS. 2-9. The rails 20 can themselves be supported by spacer elements 22 secured to a secure surface, such as the ground, or floor, 23. A conveyor pit 25 for receiving cutting waste is defined between the spacer elements 22. The workpiece support portion 12 can also include a workpiece backstop 24 (see FIGS. 2-5) extending vertically, or perpendicularly, adjacent a rearwardly positioned one of the two spaced-apart rails 20. The backstop 24 can be a generally elongate plate-like member extending lengthwise in the longitudinal direction and have a substantially flat surface against which a workpiece can be placed.

The carriage portion 14 includes spaced-apart guide rails 26, 28 secured to the ground 23 and extending parallel to each other and the rails 20 of the workpiece support portion 12. Guide rails 26, 28 are positioned proximate, but spaced-apart from, rails 20. The carriage portion 14 further includes a carriage base 30 supported by and movable along the guide rails 26, 28 as indicated by direction arrow 29. Referring to FIGS. 2, 4 and 5, the base 30 includes four side members coupled together to form a generally rectangular frame. More specifically, in the illustrated implementation, the base 30 includes a front side member 32, back side member 34 spaced apart from the front side member, and spaced apart left and right side members 36, 38 extending between and transversely from the front and back side members. As shown, the front side member 32 can be formed from a length of rectangular hollow structural tubing and the back, left and right side members 34, 36, 38 can be formed from a rectangular plate.

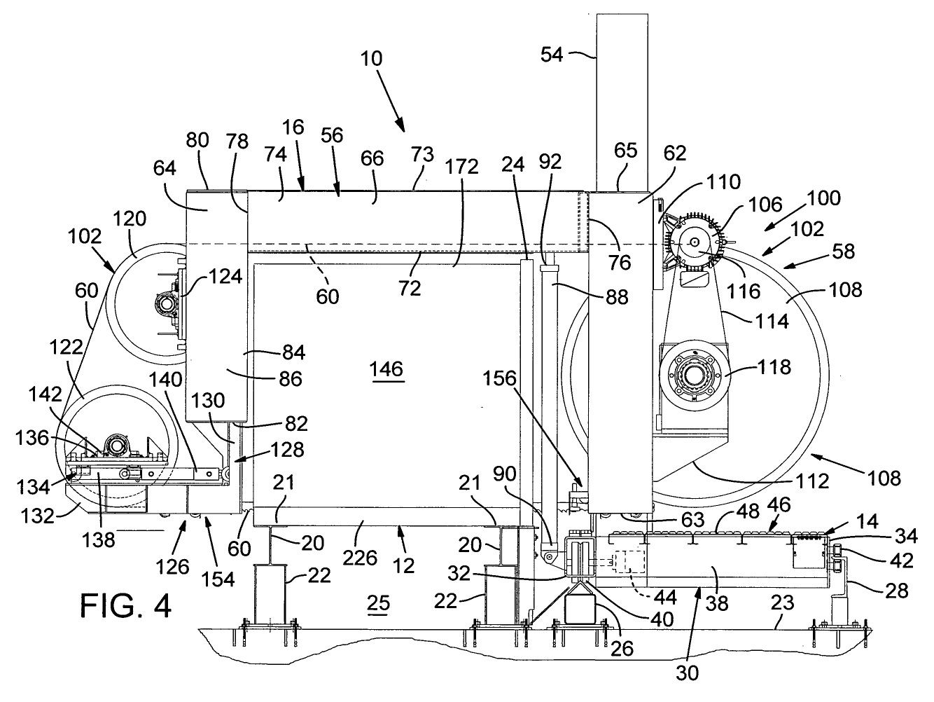

The front and rear side members 34, 36 include guide wheels configured to engage and roll along the guide rails 26, 28. For example, in the illustrated embodiment, a pair of guide wheels 40 are mounted to the front side member 34 with each guide wheel positioned proximate a respective end of the front side member. The guide wheels 40 include a circumferential groove along an outer surface of the wheel that is configured to receive a protrusion of the guide rail 26 to maintain the guide wheels in engagement and alignment with the guide rail. Similarly, the base 30 includes two pair of opposing rollers 42 proximate the back side member 38 and configured to engage and roll along the guide rail 28. For example, the guide rail 28 can include a C-shaped beam with an upper cantilevered portion extending between the rollers of each pair of opposing rollers 42. At least one of the guide wheels 40 can be coupled to a motor, such as motor 44 (see FIG. 4). The motor 44 can be activated to rotate the guide wheel 40 to move the base 30, and thereby the carriage portion 14, along the guide rails 26, 28 in a direction parallel to the rail 20.

The carriage portion 14 also includes an operator stand 46 for supporting an operator and providing the operator with safe operation control of the trim saw 10. The operator stand 46 can include a support platform 48 mounted to the base 30 and a safety shield 50 extending vertically from the support platform. Referring to FIG. 1, the safety shield includes a transparent portion 52 made from a transparent material, such as plexiglass, through which the operator can observe the operations of the trim saw 10. Although not shown, the operator stand 46 includes a control panel from which operation of the trim saw can be controlled.

The cutting portion 16 includes a vertical column 54 mounted to the base 30 of the carriage portion 14. The column 54 can be made of quadrangular hollow structural tubing with at least partially planar side surfaces. As shown, the column 54 extends generally perpendicularly relative to the ground 23. The column 54 can be mounted to the base 30 via any of various known coupling techniques, such as welding and through use of fasteners and/or brackets. For example, in certain implementations, the column 54 is fixed relative to the carriage portion 14. In such implementations, the column 54 can be welded to the base 30. In other implementations, the column 54 can be coupled to the base 30 via a rotatable bearing (not shown), such as a slewing ring bearing, to facilitate rotation of the column about a vertical axis. The bearing can be bolted to the base 30 and the column can be bolted to the bearing. Rotation of the column 54 can facilitate angled or mitered vertical cuts of a workpiece at any of various angles and allow the trim saw 10 to be easily transported for mobile or remote applications.

The cutting portion 16 also includes a saw blade support arm 56 movably coupled to the column 54 and configured to support a saw blade drive mechanism 58 on which a saw blade 60 is circulated. In the illustrated embodiment, the support arm 56 includes a first upright member 62, a second upright member 64 spaced-apart from the first upright member and an overhead member 66 extending between the first and second upright members.

In the illustrated embodiment, the first upright member 62 includes four elongate plates coupled together, such as by welding, to form a generally rectangular, elongate and hollow structure. The first upright member 62 extends approximately upwards from a lower end 63 to an upper end 65. The first upright member 62 defines an interior channel 68 that has a cross-sectional shape larger than the cross-sectional shape of the column 54. The column 54 extends through the interior channel 68 and the first upright member 62 is supported by and movable along a length of the column via a plurality of guides, e.g., guide wheel assemblies 70. Each guide wheel assembly 70 is secured to the first upright member 62 and positioned within the interior channel 68 such that each wheel of the guide wheel assemblies is in contact with the outer surface of the column 54. The guide wheel assemblies 70 facilitate movement of the first upright member 62 relative to, or along, the column 54 via rotation of the wheels in contact with the column. Accordingly, the wheels of the guide wheel assemblies 70 roll along the column to at least partially support, align and facilitate vertical movement of the first upright member 62 relative to the column 18.

Although the illustrated embodiments show guide wheels attached to the upright portion, it is recognized that the guide wheels can be attached to the column to provide the same benefits as described above. Additionally, although guide wheel assemblies are shown, in other embodiments, any known coupling technique capable of providing a low-friction interface between the upright portion and the column, such as linear bearings, can be used instead of or in conjunction with guide wheel assemblies.

The overhead member 66 of the saw blade support arm 56 is coupled to and extends generally horizontally and transversely away from the first upright member 62. In specific implementations, the overhead member 66 has four sides and a generally rectangular cross section. For example, the overhead member 66 includes lower and upper plates 72, 73 coupled to two spaced apart side plates 74 that extend upwardly and transversely from the lower and upper plates. In other implementations, however, the overhead member 66 can have any of various cross-sectional shapes, be formed of several coupled components or be formed of a one-piece unitary structure.

The overhead member 66 extends above the rails 20 from a proximal end 76 at a location rearward of the rails to a distal end 78 at a location forward of the rails. The second upright member, or cantilevered member, 64 is coupled to the overhead member 66 at an upper fixed end 80 and extends vertically downward to terminate at a lower free end 82. Similar to the overhead member, in certain implementations, the second upright member 64 has three sides and a generally U-shaped cross-section. For example, the second upright member 64 includes a inner plate 84 coupled to two spaced-apart side plates 86 that extend inwardly and transversely from the inner plate.

As described, the overhead member 66 is coupled to the first upright member 62 and the second upright member 64 is coupled to the overhead member. Accordingly, as the first upright member 62 moves vertically relative to the column 54, the support arm 56, which includes the second upright member 64 and the overhead member 66, moves vertically relative to the column. Further, the rails 20 are vertically fixed relative to the column 54. Therefore, the support arm 56 moves vertically relative to the rails 20 as the first upright member 62 moves along the column 54.

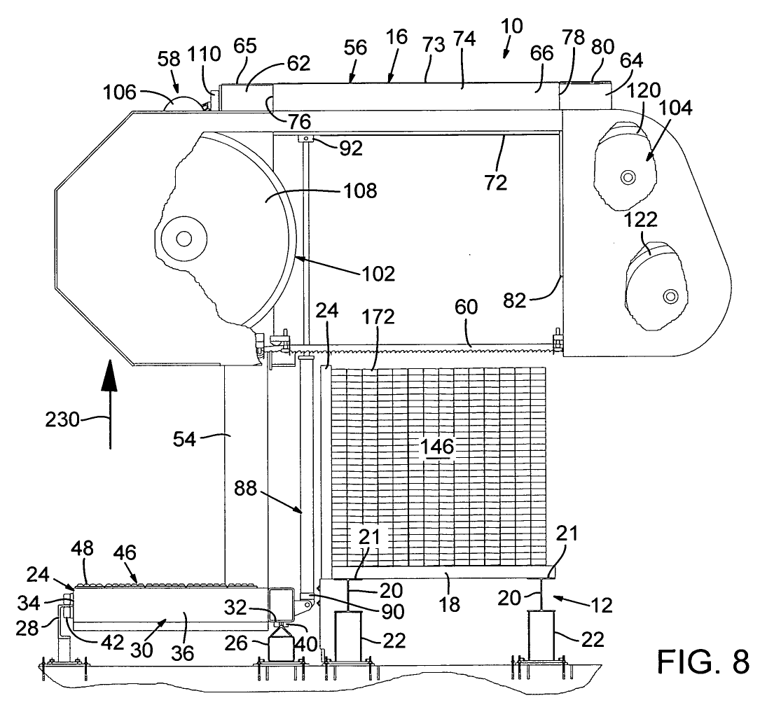

In some embodiments, vertical movement of the support arm 56 relative to the rails 20 is facilitated by one or more actuators, such as actuator 88. The actuator 88 can be any of various conventional linear actuators, such as a hydraulic or pneumatic actuator, and have an anchor end 90 attached to the carriage portion 14, such as the front side member 32 of base 30, and a shaft end 92 attached to the support arm 56, such as the lower plate 72 of overhead member 66. The actuator 88 can be selectively actuated to extend the shaft end 92 away from the anchor end 90 to correspondingly move the first upright member 62 upward along the column 54 and raise the support arm 56 relative to the rails 20 (see FIG. 8). Similarly, the actuator 88 can be selectively actuated to retract the shaft end 92 toward the anchor end 90 to move the first upright member 62 downward along the column 54 and lower the support arm 56 relative to the rails 20. Accordingly, the actuator 88 can be selectively activated to raise the support arm 56 into any of various positions between an open or fully raised position (see, e.g., FIG. 8) and a closed or fully lowered position (see, e.g., FIGS. 1-7).

Although the anchor end 90 is shown mounted to the carriage portion 14 and the shaft end 92 is shown mounted to the support arm 56, in some embodiments, the configuration of the actuator 88 can be reversed such that the anchor end is mounted to the support arm and the shaft end is mounted to the carriage portion.

The cutting portion 16 further includes a band saw blade drive mechanism 100. The blade drive mechanism 100 includes a driving portion 102 spaced apart from a driven portion 104.

As shown, in the illustrated embodiment, the driving portion 102 is coupled to the support arm 56 at a location rearward of the rails 20. The driving portion 102 includes a driving device, such as motor 106, in mechanical communication with a driving wheel 108 to rotate the driving wheel. The motor 106 can be any of various motors known in the art, such as an electrical motor. The motor 106 is mounted to the first upright member 62 via mounting bracket 110. Similarly, the driving wheel 108 is mounted to the first upright member 62 via mounting bracket 112 at a location spaced apart from the mounting bracket 110. In some implementations, the driving wheel 108 is in mechanical communication with the motor 106 via a belt and pulley arrangement. For example, as shown, a belt 114 is coupled to an input axle pulley 116 of the motor 106 and an output axle pulley 118 of the driving wheel 108. Desirably, the input and output axle pulleys 116, 118 rotate about respective axes that are parallel to each other and parallel to horizontal or ground 23. The motor 106 can be activated to rotate the input axle pulley 116, which, due to friction between the belt 114 and pulleys 116, 118 causes the output axle pulley 118, and thus the driving wheel 108, to correspondingly rotate.

The relative sizes of the input and output axle pulleys 116, 118 define a drive ratio that indicates the speed of rotation of the driving wheel 108 relative to that of the motor 106. For example, the motor 106 can be a 15HP electric motor with a maximum operating speed of approximately 1760 RPM. In one specific exemplary implementation, the driving wheel 108 has a diameter of approximately 52 inches and the drive ratio is approximately 1:0.43, e.g., the input axle pulley 116 of the motor can be approximately six inches in diameter and the output axle pulley 118 of the driving wheel can be approximately 14 inches. In this exemplary implementation, with the motor 106 operating at 1760 RPM, the driving wheel 108 would rotate at approximately 754 RPM such that the driving wheel 108 would have a tangential velocity of approximately 10,250 feet per minute, which would cause a band saw blade to circulate at the same rate or velocity.

It is specifically recognized that the above exemplary embodiment is for illustrative purposes only and that the belt drive ratio, electrical motor characteristics and driving wheel characteristics can vary to produce various band saw blade circulation rates. Further, it is recognized that the electrical motor can be infinitely adjustable by a user, such as through use of a controller, to provide infinitely adjustable band saw blade circulation rates. For example, a variable frequency drive (VFD) is used in some embodiments. Among other advantages, the VFD allows for speed changes to be ramped up or down smoothly.

Although not shown, in an alternative implementation, the driving device of the driving portion 102 can be mechanically coupled with the driving wheel via another coupling arrangement, such as a gear arrangement.

As also shown, the driven portion 104 is coupled to the support arm 56 at a location forward of the rails 20. The driven portion 104 includes a pair of saw blade guide wheels, such as upper guide wheel 120 and lower guide wheel 122.

The upper guide wheel 120 is coupled to the second upright member 64 of the support arm 56 by one or more bearing units, such as a pair of pillow block bearings 124, mounted to the second upright member. The bearings 124 are positioned on opposing sides of the wheel 120 and an axle of the wheel is secured to the bearings. The bearings 124 facilitate rotation of the upper guide wheel 120 relative to the second upright member 64.

The lower guide wheel 122 can also be coupled directly to, and rotatable relative to, the second upright member 64 in the same manner as the upper guide wheel 120, i.e., via one or more bearing units. However, as shown, in some implementations, the lower guide wheel 122 can be indirectly coupled to the second upright member 64 via a trim saw blade tensioning assembly 126 mounted to the second upright member. The tensioning assembly 126 includes a bracket 128 having a vertical portion 130 and a horizontal portion 132. As shown, the vertical portion 130 is mounted to and extends generally downwardly from the second upright member 64 and the horizontal portion 132 extends generally forwardly and transversely away from the vertical portion.

The tensioning assembly 126 includes a blade tensioning mechanism 134 mounted to the horizontal portion 132 of the bracket 128. The tensioning mechanism 134 includes a bearing unit support member 136 in moveable engagement with bearing unit support member tracks or rails 138. The rails 138 are fixed relative to the horizontal portion 132 and the bearing unit support member 136 includes followers (not shown) attached to and slidable along the rails to facilitate movement between the rails and support member. The bearing unit support member 136 includes a pair of axially aligned, spaced-apart bearing units, such as pillow block bearings 142. The bearings 142 are configured to receive and secure an axle of lower guide wheel 122, and facilitate rotation of the wheel relative.

The tensioning mechanism 134 includes an actuator 140 coupled to the vertical portion at an anchor end and the bearing unit support member 136 at a shaft end. The actuator can be a conventional actuator, such as a hydraulic or pneumatic actuator. The actuator is operable to extend and retract the shaft end relative to the anchor end to move the bearing unit support member 136 along the tracks 138 via the followers forwardly and rearwardly, e.g., away from and toward the rails 20. Accordingly, the lower guide wheel 122 can be linearly movable away from and toward the rails 20 by selectively actuating the actuator.

Although the illustrated embodiment includes a tensioning assembly separately mountable to the second upright member 64, in some embodiments, the tensioning assembly can be integrally formed as a one piece unit with the second upright member.

As described above, the band saw blade drive mechanism 100 of trim saw 10 includes three wheels: one large driving wheel 108 and two smaller tensioning or guide wheels 120, 122. Such a three-wheel drive mechanism provides several advantages over conventional two-wheel drive mechanisms on known trim saws. For example, conventional two-wheel drive mechanisms require two large wheels, i.e., a large driving wheel and a large tensioning wheel, each having a large footprint and occupying large amounts of space. Replacing the large tensioning wheel with two smaller tensioning wheels, having smaller footprints and occupying less space, reduces the overall size and footprint of the trim saw.

As shown, an endless band saw blade 144 is encircled about and in contact with at least a portion of the outer peripheral surfaces of the wheels 108, 120, 122. Installation of the band saw blade 144 can include positioning the lower guide wheel 122 in a blade mounting position as shown in dashed lines in FIG. 2. The band saw blade 144 can then be loosely slipped over the wheels 108, 120, 120. The lower guide wheel 122 can then be moved forwardly into a second blade tensioning position such as shown in FIG. 2. The second blade tensioning position of the lower guide wheel 122 can vary based on the specific characteristics, such as the length, of the band saw blade 144. With the lower driven wheel 122 in a proper second blade tensioning position, the saw blade 144 is properly tensioned to remains frictionally engaged with the circumferential surfaces of the wheels 108, 120, 122 as the blade circulates about the wheels.

In some embodiments, the actuator 140 is electrically coupled to a controller (not shown) and selectively actuatable by operation of the controller to adjust the lower guide wheel 122 and the tension in the band saw blade 144. Alternatively, the controller can be programmed to actively, automatically and in situ adjust the position of the lower guide wheel 122 to maintain a predetermined tension of the band saw as will be described in more detail below. In yet other embodiments, instead of an actuator, the position of the lower guide wheel 122 can be adjusted manually, such as by moving the bearing unit support member 136 along the tracks 138 via manual rotation of a threaded rod.

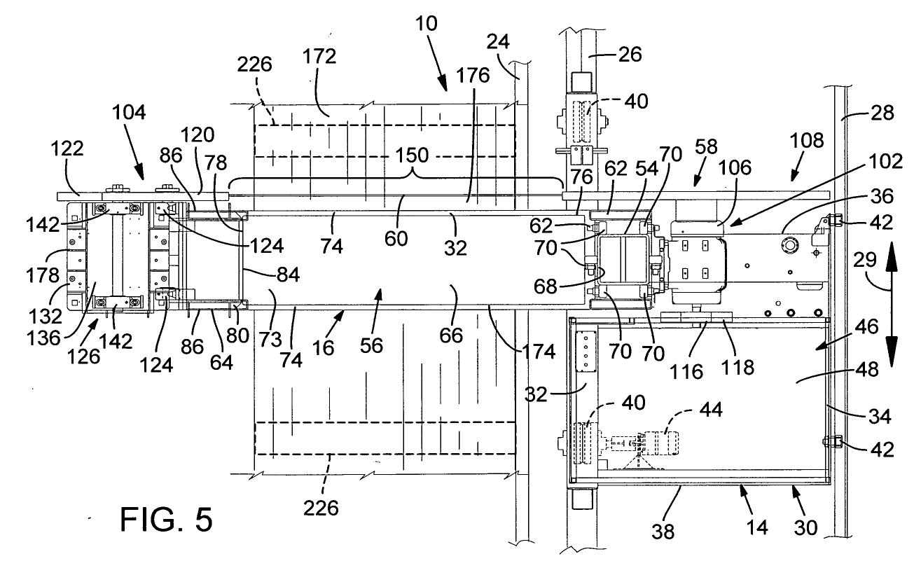

The blade drive mechanism 100 operates to drive or circulate the band saw blade 144 about a workpiece receiving area 146 defined between the support arm members and through a workpiece cutting zone 146 in which a workpiece is cut. The wheels 108, 120, 122 of the blade drive mechanism 100 are aligned with each other and offset from, or spaced to a side of, the support arm 56 (see FIG. 5). Referring to FIG. 2, the motor 106 drives the driving wheel 108 in a counterclockwise direction 152, which causes a properly tensioned blade 144 to correspondingly circulate in the counterclockwise direction.

The circulating mechanism 16 drives the band saw blade 15 along a path from the driving wheel 108 at a location above the workpiece receiving area 146 to the upper guide wheel 120 also at a location above the material receiving area. In some implementations, the driving wheel 108 and upper guide wheel 120 are sized and positioned such that the band saw blade 144 is driven generally parallel to the rail support surfaces 21, e.g., in a generally horizontal direction, from the driving wheel to the upper guide wheel. From the upper guide wheel 120, the band saw blade 144 is driven in a generally downwardly direction to the lower guide wheel 122. From the lower guide wheel, the blade is driven generally parallel to the rail support surfaces 21 through the workpiece cutting zone 150 and back to the driving wheel 108. The workpiece cutting zone 150 can be described generally as a path between the first and second upright members 62, 64 along which the band saw blade 144 travels from the lower guide wheel 122 to the driving wheel 108.

The endless band saw blade 144 can be any of various conventional band saw blades having any of various sizes and dimensions commonly known in the art. Generally, an endless band saw blade can be described as an endless length of material having opposing broad flat surfaces intermediate two edges with at least one of the edges having a plurality of cutting projections, such as tooth-shaped projections. The width, or height, of a blade can be described as the shortest distance from the tips of the tooth-shaped projections to the opposite edge and the thickness of a blade can be described as the shortest distance between the opposing broad flat surfaces. The saw blade 144 can be any of various known saw blades having any of various blade widths, thicknesses, lengths, tooth sets and tooth styles. For example, in some implementations, the saw blade 144 can have a blade width between approximately 1.5 inches and approximately 2.0 inches and a blade thickness between approximately 0.040 inches and approximately 0.075 inches. In one specific implementation, the saw blade 144 has a blade width of approximately two inches and a blade thickness of approximately 0.063 inches. In some embodiments, a Lenox Model Contestor GT blade is used. The Contestor GT blade is a variable tooth (VT) blade with a 0.75/1.0 tooth per inch ratio.

Band saw blade 144 can also be described as defining a cutting plane that is generally coplanar with the broad flat surfaces of the blade. In other words, the band saw blade cutting plane extends along, or is parallel to, the width of the blade. As with conventional band saw blade circulation wheels, the wheels of the drive mechanism 100 are configured to support the band saw blade flat against the wheels, i.e., with the cutting plane of the band saw blade extending parallel to the axis of rotation of the wheels. For example, the wheels of the drive mechanism 100 contact and support the band saw blade 144 in a horizontal orientation, i.e., the cutting plane of the band saw blade extends approximately parallel to the rail support surfaces 21. Further, the cutting plane of the band saw blade 144 as it is driven from the driving wheel 108 to the upper guide wheel 120, and from the upper guide wheel to the lower guide wheel 122 is approximately parallel to the rail support surfaces 21.

Prior to entering the workpiece cutting zone 150 and soon after exiting the cutting zone, the trim saw blade 144 is reoriented such that the cutting plane of the blade extends perpendicularly relative to the rail support surfaces 21. To facilitate reorientation of the saw blade 144, the trim saw 10 includes first and second blade transition assemblies 154, 156 for rotating, twisting, or otherwise manipulating the band saw blade to reorient the cutting plane of the blade as it passes through the assemblies. The first blade transition assembly 154 is positioned intermediate the lower guide wheel 122 and the cutting zone 150, and the second blade transition assembly 156 is positioned intermediate the cutting zone and the driving wheel 108. Each blade transition assembly includes one or more blade guides positioned along the blade path in contact with the blade. Each blade guide is configured and oriented to cause the cutting plane of the blade 144 to rotate a predetermined amount.

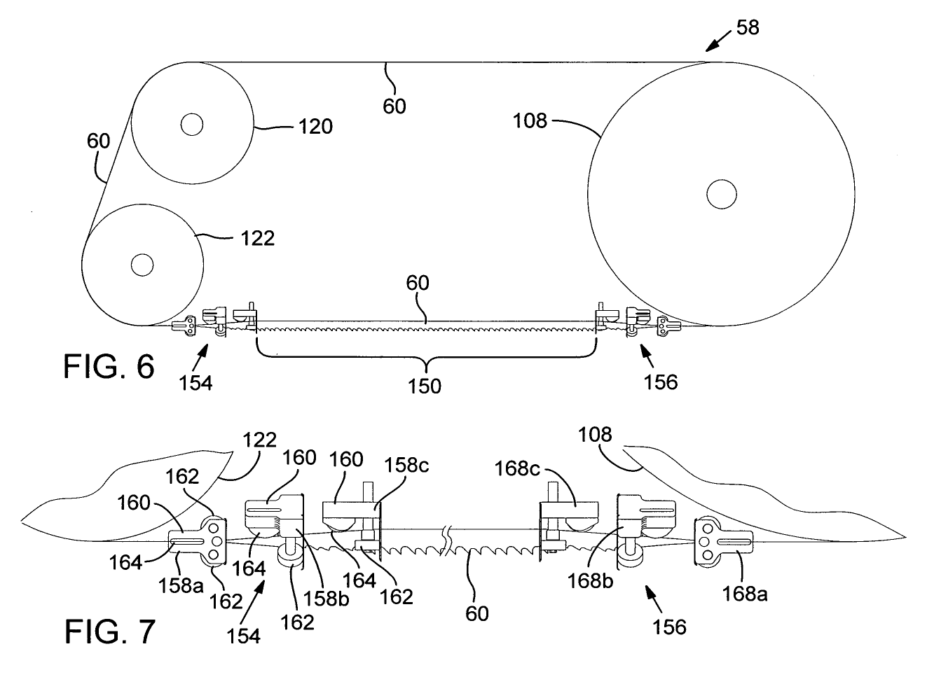

For example, as shown in FIGS. 6 and 7, the first blade transition assembly 154 includes three blade guides 158a, 158b, 158c spaced apart along the blade path intermediate the lower guide wheel 122 and the workpiece cutting zone 150. Each blade guide includes a body portion 160, a pair of opposing rollers 162 coupled to the body portion, and a stabilizer roller 164 wheel coupled to the body portion. The blade 144 is received between the opposing rollers 162 with each roller contacting and rolling along opposite broad side surfaces of the blade as the blade passes between the rollers. The stabilizer roller 164 act as a thrust bearing and stabilizer for the blade by contacting and rolling along the edge of the blade opposite the toothed edge as the blade circulates past the stabilizer roller. Each of the opposing rollers 162 and the stabilizer roller 164 rotate about a central axis. The axes of the opposing rollers 162 are substantially parallel to each other and extend in a direction substantially perpendicular relative to the direction of the axis of the stabilizer roller 164.

Referring to FIGS. 1, 6 and 7, the blade guides 158a, 158b, 158c of the first blade transition assembly 154 are mounted to the tensioning assembly 126. Each of the three blade guides 158a, 158b, 158c are mounted at different orientations relative to each other. For example, the first blade guide 158a is oriented such that the axes of the opposing rollers 162 are substantially parallel to the rail support surfaces 21, i.e., parallel to horizontal, and the axis of the stabilizer roller 164 is substantially perpendicular to the rail support surfaces. The second blade guide 158b is positioned intermediate the first and third blade guides 158a, 158c and oriented such that the axes of the opposing rollers 162 are angled between 0° and 90° relative to the rail support surfaces 21. In some implementations, the axes of the opposing rollers 162 of the second blade guide 158b are angled approximately 45° with respect to the rail support surfaces 21. The third blade guide 158c is oriented such that the axes of the opposing rollers 162 are substantially perpendicular to the rail support surfaces 21.

Similar to the first blade transition assembly 154, the second blade transition assembly 156 includes blade guides 168a, 168b, 168c spaced apart along the blade path, but intermediate the workpiece cutting zone 150 and the driving wheel 108. The blade guides 168a, 168b, 168c have the same components as blade guides 158a, 158b, 158c. Generally, the blade guides 168a, 168b, 168c are mounted at different orientations relative to each other to effectively mirror the orientations of the blade guides 158a, 158b, 158c across the cutting zone 150. For example, the axes of rollers 162 of blade guide 168c are perpendicular to the rail support surfaces 21, the axes of rollers 162 of blade guide 168b are angled between 0° and 90° relative to the rail support surfaces, and the axes of rollers 162 of blade guide 168a are parallel to the rail support surfaces.

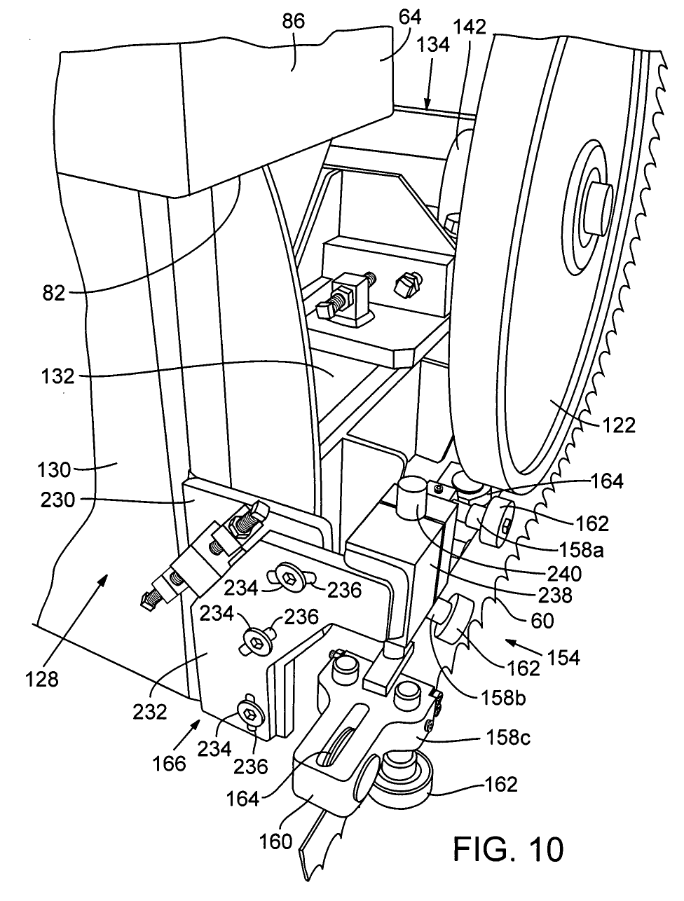

The blade guides 158a-c, 168a-c are adjustably coupled to the respective portions of the support arm 56 via brackets. For example, referring to FIGS. 1 and 10, the blade guides 158c, 168c are adjustably secured to brackets 166, 170, respectively (brackets not shown in FIGS. 2-9). Reference is now made to FIG. 10, which shows further detail of the bracket 166, from which details of the bracket 170 also will be understood. Bracket 166 includes a mounting plate 230 fixedly secured to and extending transversely relative to the bracket 128 of the support arm 56. A guide wheel support plate 232 is pivotably secured to the mounting plate 230 by fasteners, such as fasteners 234. The mounting plate 230 includes angled slots 236 through which a corresponding one of the fasteners 234 extends. The slots 236 are angled such that when the fasteners 234 are loosened, the fasteners can freely travel within the slots 236 to allow the guide wheel support plate 232 to pivot relative to the mounting plate 230. The fasteners 234 can be tightened against the support plate 232 to secure the support plate in place.

The bracket 166 further includes a clamp 238 which securely receives an attachment rod 240 secured to the body 160 of the blade guide 158c. The clamp 238 is secured to the support plate 232 and includes two opposing portions each having opposing grooves within which the attachment rod 240 extends. The two portions of the clamp are secured together via one or more fasteners (not shown) to secure the attachment rod 240 within the grooves. The clamp fasteners can be loosened to allow the rod 240 to freely rotate within the grooves about an axis of the rod such that blade guide 158c can be oriented into a desired position. Once the blade guide 158c is in the desired position, the clamp fasteners are tightened to secure the blade guide in the desired position. Or alternatively, with the clamp fasteners loosened, the blade guide 158c can be removed if desired.

Based on the foregoing, the bracket 166 facilitates infinite adjustment of the orientation of the blade guide 158c. In other words, the position of the support plate 232 relative to the mounting plate 230 can be cooperatively adjusted along with the position of the attachment rod 240 relative to the clamp 238 to place the blade guide 158c in one of an infinite number of orientations.

The blade guides 158a, 158b, 168a, 168b can be secured to the support arm 56 and adjustable via a bracket that is the same as or similar to bracket 166. However, in the illustrated embodiments, the blade guides 158a, 158b, 168a, 168b are adjustably secured to the support arm 56 via a bracket, such as brackets 171 (see FIG. 1), having the same general configuration as the clamp 238 of bracket 166 (brackets not shown in FIGS. 2-9). Brackets 171 each include two opposing portions each having opposing grooves within which an attachment rod, such as rod 240, of a respective blade guide 158a, 158b, 168a, 168b extends. One of the opposing portions is fixedly secured to the support arm 54 and the other opposing portion is removably secured to the fixed portion via one or more fasteners. Depending on the desired orientation of the blade guide, the fixed portion can be attached to the support arm 54 in any of a number of orientations. For example, the brackets 171 securing blade guides 158a, 168a can be attached to the support arm 54 such that the opposing grooves extend in a direction parallel to the axis of the rollers 168. Further, the brackets 171 securing blade guides 158b, 168b can be attached to the support arm 54 such that the opposing grooves extend in a direction downwardly away from the support arm at an angle of approximately 45° relative to horizontal.

The orientation of each of the blade guides 158a, 158b, 168a, 168b can be adjusted by loosening the opposing portions of an associated bracket 171 and rotating the blade guide about the axis of the its attachment rod. When in a desired orientation, the opposing portions can be tightened together to secure the blade guide in place. Alternatively, when the opposing portions are loosened, the blade guide can be removed, such as shown in FIG. 10.

In operation, after being driven from the lower guide wheel 122, the blade 144 is received by, and passes between the rollers 162 of, the blade guide 158a of the first blade transition assembly 154 in a horizontal orientation. As the saw blade circulates from the blade guide 158a to the second blade guide 158b, the saw blade 144 twists from the horizontal orientation into an intermediate orientation between the horizontal orientation and a vertical orientation, i.e., an orientation where the cutting plane of the band saw blade extends approximately perpendicular to the rail support surfaces 21. The saw blade is then received by, and passes between the rollers 162 of, the blade guide 158b in an intermediate orientation equal to the angle of the axes of the rollers with respect to the rail support surfaces 21. As the saw blade 144 circulates from the blade guide 158b and into the blade guide 158c, the saw blade twists from the intermediate orientation into the vertical orientation preparatory to entering the workpiece cutting zone 150.

The saw blade 144 circulates through the workpiece cutting zone 150 and is received into the blade guide 168c of the second blade transition assembly 156 in the vertical orientation. As the saw blade 144 circulates from the blade guide 168c into the blade guide 168b, the saw blade twists from the vertical orientation into an intermediate orientation between the horizontal and vertical orientations. The saw blade 144 twists from the intermediate orientation into the horizontal orientation as it circulates from the blade guide 168b into the blade guide 168a. The saw blade 144 remains in the horizontal orientation as it is circulated from the blade guide 168a into contact with the driving wheel 108. From the driving wheel 108, the blade 144 is driven about the workpiece receiving area 146 in the horizontal orientation until it is again reoriented by the first blade transition assembly.

Although each of the first and second blade transition assemblies 154, 156 of trim saw 10 are shown having three blade guides, in other embodiments, the trim saw can include blade transition assemblies with more or less than three blade guides. For example, the first and second blade transition assemblies 154, 156 can each have two blade guides. In these embodiments, first blade transition assembly 154 includes only blades guides 158a, 158c and second blade transition assembly 156 includes only blade guides 168a, 168c. In other words, the first and second blade transition assemblies 154, 156 do not include respective blade guides 158b, 168b, i.e., intermediate blade guides that orient the blade into an angle intermediate parallel and perpendicular to horizontal. Rather, the blade is twisted from the horizontal position directly to the vertical position after passing through the blade guide 158a and into the blade guide 158c. Similarly, the blade is twisted from the vertical position directly to the horizontal position after passing through the blade guide 168c and into the blade guide 168a.

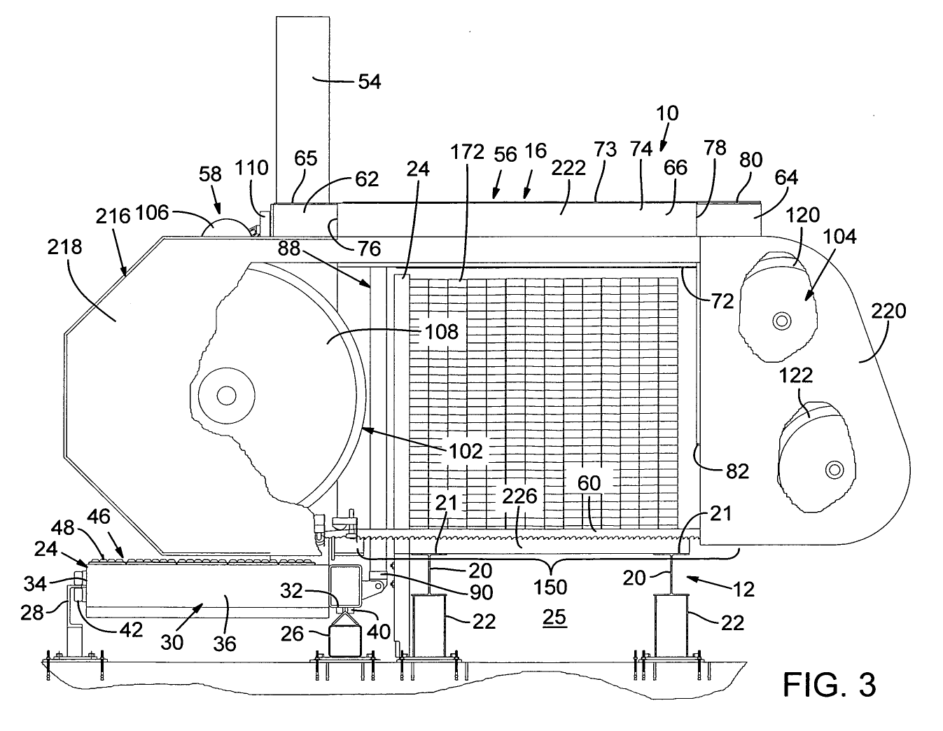

As shown in FIG. 3, the trim saw 10 includes first and second wheel covers 216, 218 to protect the wheels from debris and operators from injury. The first wheel cover 216 is mounted to the first upright member 62 and at least partially covers the driving wheel 108. The second wheel cover 218 is mounted to the second upright member 64 and at least partially covers the upper and lower guide wheels 120, 122. In certain implementations, the wheel covers 216, 218 are removable from the respective upright members to facilitate access to the wheels if necessary. In other implementations, the wheel covers 216, 218 each include an access panel that can be opened, such as by moving or pivoting the panel away from the respective wheels.

In a cross-cut operation, the actuator 88 is operated to raise the cutting portion 16 vertically upward as indicated by arrow 230 into the open or fully raised position to place the cutting zone 150 at a maximum distance away from the rail support surfaces 21 (see FIG. 8). In other words, when the trim saw 10 is in the open position, a maximum clearance is defined beneath the blade 144 and the rail support surfaces 21 to allow a workpiece, such as workpiece 172, having a maximum height to be positioned on the rail support surfaces 21 beneath the blade 144. In certain exemplary implementations, the maximum clearance is greater than approximately four feet such that workpieces having a height equal to approximately four feet can be positioned beneath the blade 144 to be cut. Further, the first and second upright members 62, 64 and the first and second blade transitioning assemblies 154, 156 are spaced apart such that a workpiece having a maximum width, such as, in one example, equal to approximately 52 inches, can be positioned beneath the blade 144 to be cut. In general, a workpiece, can be a single unit, such as a log, or more commonly, the workpiece is a pack of multiple workpiece units, such as shown in FIG. 3. Typically, workpieces are placed upon dunnage or chocks, such as, for example, multiple spaced-apart boards 226, laid transversely across and supported by the rails 20 prior to the workpiece being cut (see FIGS. 3-5). In some implementation, the boards 226 are secured to the workpieces to form an integral workpiece pack or bundle.

Of course, the cutting portion 16 can be raised to intermediate positions defining intermediate clearances in the event workpieces have less than a maximum height. The workpiece is positioned on the rail support surfaces 21 (or dunnage boards 226 if used) such that the portion of the workpiece to be cut is positioned directly below the cutting zone 150. When the workpiece is properly positioned, the actuator 88 can be operated to lower the cutting portion 16 such that the driven blade 144 penetrates or cuts the workpiece at the desired location. The cutting operation is continued, i.e., the cutting portion 16 is lowered, until the trim saw 10 is placed in the closed or fully lowered position. In the closed position, the workpiece cutting zone 150 extends at least partially below that the workpiece such that the blade 144 penetrates completely through the workpiece.

A workpiece to be cut can be properly positioned onto the rails 20 by using any of several techniques. For example, conventional side-loading techniques typically used in mass-quantity lumber cutting applications can be used. In one implementation, trim saw 10 can be used in conjunction with a workpiece conveyor system positioned upstream and downstream of the trim saw. Workpieces to be cut can be loaded onto the conveyor system at a loading location upstream of the trim saw and conveyed onto the rails 20 via an upstream side 174 of the trim saw 10 (see FIG. 5). Once the cutting operation is completed, the cutting portion 16 can be raised and the cut workpiece can be conveyed from of the rails 20 via a downstream side 176 of the trim saw to an unloading location downstream of the trim saw. In this manner, workpieces are loaded from a side of the trim saw 10 and unloaded from an opposite side of the trim saw 10.

It may be desirable to cut a single workpiece into two or more portions. Accordingly, in some implementations, once a first cutting operation is completed, the workpiece can be conveyed into a second cutting position such that the workpiece can be cut again at a different location. Alternatively, the carriage portion 14 can be operable to travel linearly along the workpiece in an upstream of downstream direction until the workpiece cutting zone 150 is properly positioned above another location on the workpiece at which a cut of the workpiece is desired.

Additionally, as opposed to conventional double-column vertical band saws used in mass-quantity lumber cutting applications, the trim saw of the present application is a formed of a single-column construction. In other words, because the second upright member 64 is cantilevered, i.e., has one fixed end and one open, or un-fixed, end, the cutting portion 16 is supported by movable engagement between the first upright member and the single support column 54. As the cutting portion 16 is raised above the closed position, a clearance for receiving workpieces is created between the second upright member 64 (and tensioning assembly 126) and the rail support surfaces 21. Accordingly, a workpiece can be front-loaded into position on the rails 20 via the clearance between the upright member 64 and the surfaces 21. If desirable, a conveyor system can be positioned adjacent a front end 178 of the trim saw 10 to convey workpieces into a proper cutting position via the front end.

The front-loading capability facilitated by the single-column construction of the trim saws described herein can be particularly advantageous if due to space limitations, workpiece dimensions, etc, side-loading is not desirable or practical.

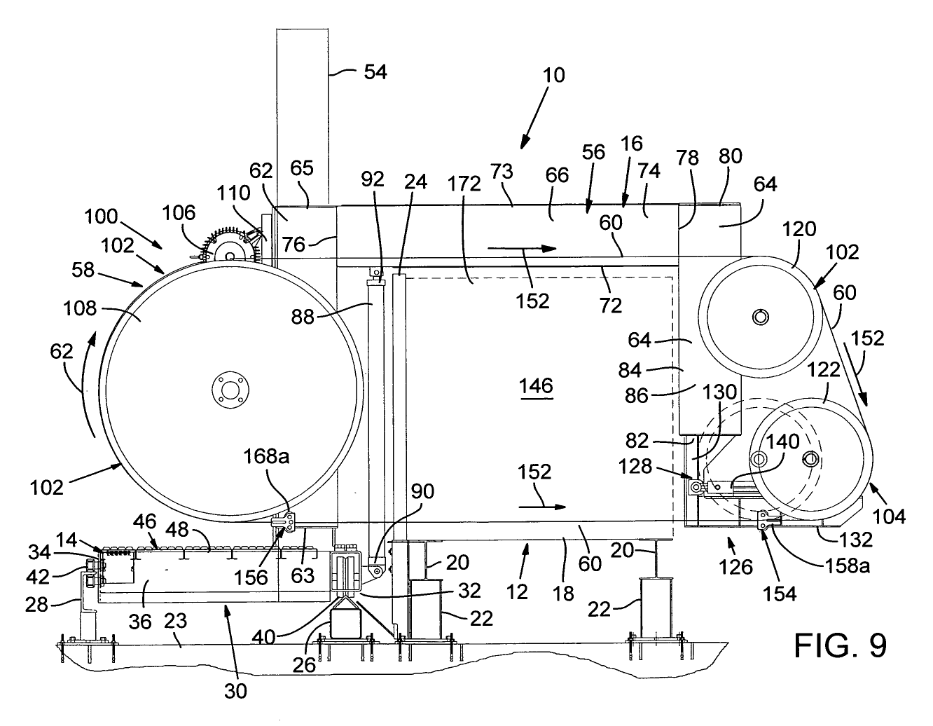

In some embodiments, the trim saw 10 is operable to perform cross-cutting applications and splitting, or ripping, applications. For example, as shown in FIGS. 1-8, trim saw 10 is configured in a first mode to perform cross-cutting operations on workpieces positioned in the cutting zone 150. The trim saw 10 can be quickly and conveniently switched from the first mode to a second mode for performing splitting operations on workpieces moving through a redefined cutting zone 150. Referring to FIG. 9, trim saw 10 is shown configured in the second mode. More specifically, the blade guides 158b, 158c of first blade transition assembly 154 have been removed and the blade guides 168b, 168c of the second blade transition assembly 156 have been removed. With the blade guides 158b, 158c, 168b, 168c removed, the blade 144 remains in the horizontal position as the blade is driven through the cutting zone 150 between blade guides 158a, 168a, or lower guide wheel 122 and driving wheel 108.

The blade guides 158b, 158c, 168b, 168c can be removed by loosening and removing a fastener extending through the blade guides and a respective mounting bracket, such as brackets 166, 170, 171. Alternatively, in some implementations, the blade guides can be removed by removing the brackets themselves. In other implementations, however, the blade guides are not removed, but are adjustably mounted to the brackets, such as described above, to change the orientation of the guides and maintain the blade 144 in the horizontal orientation through the cutting zone 150. In other words, the blade guides, e.g., 158b, 158c, 168b, 168c, can be reoriented into the same orientation as blade guides 158a, 168a, i.e., the axes of the rollers 162 are all parallel to horizontal.

In the second, or splitting, mode, the cutting portion 16 can be raised or lowered to place the cutting zone 150 at a desired distance away from the rail support surfaces 21. The desired distance is dependent on a height of the workpiece at which the workpiece is to be split. The vertical position of the cutting zone 150 is maintained as a workpiece to be split is passed through the cutting zone via a side of the trim saw 10, such as upstream side 174. A conventional conveyor system can be used to move the workpiece through the cutting zone 150. The circulating blade 144 performs a horizontal cut through the workpiece as the workpiece is moved through the cutting zone 150. If one or both portions of the split workpiece require further splitting, the cutting portion 16 can be lowered to place the cutting zone 150 closer to the rail support surfaces 21 and the workpiece portions again can be passed through the cutting zone to split the portions.

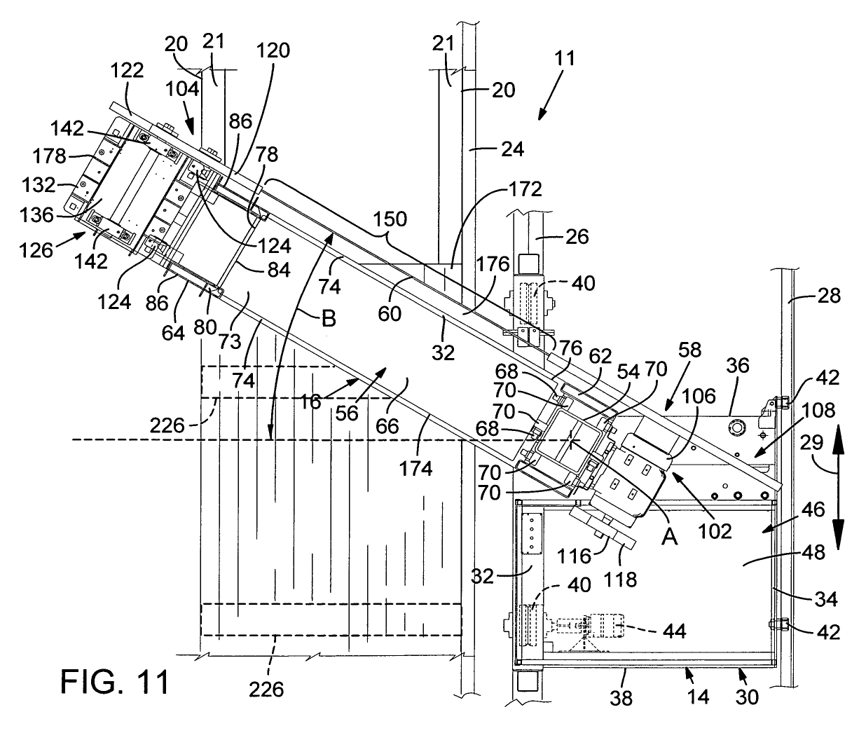

In further embodiments, the trim saw 10 is operable in a third vertical mitering mode. In the third vertical mitering mode, the blade transition assemblies 154, 156 are configured as shown in FIGS. 1-8 to drive the blade 60 through the workpiece cutting zone 150 in the vertical orientation. Like the first cross-cutting mode, the support arm 56 is raised or lowered to cut a workpiece. However, as shown in FIG. 11, in the third vertical mitering mode, the column 54 is rotated about a vertical axis A relative to the workpiece 172 such that the workpiece cutting zone 150 forms an angle B with a length of the workpiece. The column 54 can be rotated such that the angle B is between 0° and 90°. Once the workpiece cutting zone 150 is positioned in a desired angle relative to the workpiece 172, the support arm 56 is lowered to perform a mitering cut through the workpiece, e.g., a cut extending at the angle B with respect to the length of the workpiece.

In yet another embodiment, the trim saw 10 is operable in a fourth angled mitering mode. In the fourth angled mitering mode, the blade transition assemblies 154, 156 are configured to drive the blade 60 through the workpiece cutting zone 150 in a predetermined angled orientation between the horizontal and vertical orientations. For example, the blade guides 158c, 168c can be removed from brackets 166, 170, or alternatively, the blade guides can be oriented, such that the cutting plane of the blade 60 is angled to form an angle of approximately 45° with respect to horizontal or vertical as it passes through the workpiece cutting zone 150. It is recognized, that one or more of the blade guides 158b, 158c, 168b, 168c can be removed or oriented such that the cutting plane of the blade 60 is angled to form any of an infinite number of angles with respect to horizontal or vertical as it passes through the workpiece cutting zone 150. The trim saw 10 is operable to perform an angled miter cut, i.e., a cut that is angled between 0° and 90° with respect to horizontal and vertical, by vertically lowering the support arm 56 to cut the workpiece and simultaneously moving the carriage portion 14, and thereby the support arm, horizontally along side the workpiece. In certain implementations, the coordinated vertical movement of the support arm 56 and the horizontal movement of the carriage portion 14 is numerically controlled by a computing device or processing unit.

The trim saw embodiments described herein provide one or more of the several advantages over conventional trim saws as described above and as follows. One particular advantage is that operation of certain of the trim saw embodiment in lumber cutting applications reduces the amount of cutting waste, such as saw dust, and increases the amount of lumber recovery compared to conventional trim saws for cutting lumber. In one particular implementation, the width of the cut is reduced from approximately 0.340 inches, typically associated with conventional trim saws, to approximately 0.018 inches. This reduction in cut width is at least partially due to the fact that a typical chainsaw blade used in conventional trim saws for cutting lumber can have a kerf of approximately 0.350 inches whereas a typical band saw blade can have a kerf of approximately 0.080 inches. Such a reduction in cutting width results in a 75% reduction in saw dust and a 0.322 inch increase in lumber recovery per each cut. As described above, with less saw dust to be removed and less irrecoverable lumber, costs of operation are significantly reduced as thousands of cuts are typically performed each month in a single lumber mill. For example, in some implementations, the amount of cutting waste can be reduced by approximately 12 tons per year compared to conventional chainsaw blade trim saws.

Further, in certain embodiments, the trim saw 10 has a higher cut tolerance compared to conventional trim saws used in cutting lumber packs. For example, in some implementations, the trim saw 10 can maintain a cut tolerance of approximately ±0.040 inches. Moreover, the cut achieved by the trim saw 10 is of a higher quality and less aggressive than conventional trim saws for cutting lumber packs.

In view of the many possible embodiments to which the principles of the disclosed apparatus and methods may be applied, it should be recognized that the illustrated embodiments are only preferred examples and should not be taken as limiting in scope. Rather, the scope of the disclosed apparatus is defined by the following claims. We therefore claim as our invention all that comes within the scope and spirit of these claims.

We claim:

1. A reduced waste single column trim saw for cutting a workpiece having multiple aligned workpiece components that are assembled together, comprising:
a frame member comprising at least one driving wheel and at least one driven wheel;
an endless band saw blade extending about and movably retained by the at least one driving wheel and at least one driven wheel such the endless band saw blade is horizontally drivable through a workpiece cutting region, wherein the at least one driving wheel and the at least one driven wheel rotate about respective axes each approximately parallel to horizontal such that a cutting plane of the endless band saw blade prior to being driven through the workpiece cutting region is approximately parallel to the axis of the driving and driven wheels; and
a first blade turning region proximate a first end of the workpiece cutting region and a second blade turning region proximate a second end of the workpiece cutting region, wherein the endless band saw blade is turned approximately ninety degrees in the first blade turning region prior to entering the workpiece cutting region such that the cutting plane of the band saw blade is approximately perpendicular to horizontal when driven through the workpiece cutting region, and the endless band saw blade is turned approximately ninety degrees in the second blade turning region upon exiting the workpiece cutting region such that the cutting plane of the band saw blade is approximately parallel to horizontal.

2. The trim saw of claim 1, wherein the frame member is raisable along the single column into an open position, and wherein in the open position, a workpiece is loadable under the workpiece cutting region via one of a front, upstream side and downstream side of the frame member.

3. The trim saw of claim 1, wherein the frame member comprises a first vertical member coupled to the single column, a horizontal member coupled to and extending approximately transversely from the first vertical member, and a second vertical member (i) coupled to the horizontal member at a first attached end; (ii) extending approximately transversely downwardly from the horizontal member; (iii) terminating at a second unattached end; and (iv) spaced-apart from and extending approximately parallel to the first vertical member.

4. The trim saw of claim 1, wherein the first blade turning region comprises a first blade guide assembly coupled to the frame and the second blade turning region comprises a second blade guide assembly coupled to the frame, wherein the first and second blade guide assemblies engage and align the endless band saw blade.

5. The trim saw of claim 1, wherein the trim saw provides a substantial reduction in cut-induced byproducts.

6. An endless blade precision saw for cutting a lumber workpiece, comprising:
a workpiece support surface capable of receiving the lumber workpiece;
an endless saw blade operatively positioned relative to and spanning one dimension of the workpiece support surface, the endless saw blade being selectively positionable to cut the lumber workpiece; and
an endless saw blade support comprising first and second spaced-apart portions positioned at opposite sides of the workpiece support surface, the first and second spaced-apart support portions having respective wheel elements that rotatably support and selectively drive the saw blade and at least two blade guides, wherein one of the first and second support portions is cantilevered with a first fixed end and a second open end, and wherein the support portions are movable to move the endless saw blade into a raised position to allow the lumber workpiece to be positioned as desired on the workpiece support surface and to move the endless saw blade into a lowered position to contact and cut the lumber workpiece;
wherein the saw blade support defines an open working area within which the lumber workpiece can be received, wherein the saw blade support further comprises a cutting zone extending at least as long as a desired cut through the lumber workpiece, and wherein the trim saw is operable in a first mode for cross-cutting lumber workpieces and a second mode for splitting lumber workpieces.

7. The endless blade precision saw of claim 6, wherein in the cross-cutting first mode, at least one blade guide twists the blade from a horizontal orientation parallel to the workpiece support surface to a vertical orientation perpendicular to the work piece support surface prior to the blade entering the cutting zone, and at least one blade guide twists the blade from the vertical orientation to the horizontal orientation after the blade exits the cutting zone.

8. The endless blade precision saw of claim 6, wherein the at least two blade guides are capable of twisting the saw blade through a substantial angle.

9. The endless blade precision saw of claim 6, wherein in the splitting second mode, the at least two blade guides maintain the blade in a horizontal orientation parallel to the workpiece support surface when the blade is in the cutting zone.

10. The endless blade precision saw of claim 6, wherein the endless saw blade support is movable along the workpiece support surface.

11. The endless blade precision saw of claim 10, further comprising a carriage coupled to the endless saw blade support, the carriage being capable of supporting an operator and movable with the endless saw blade support along the workpiece support surface.

12. The endless blade precision saw of claim 6, further comprising a workpiece alignment stop coupled to the workpiece support surface.

13. The endless blade precision saw of claim 6, wherein the saw blade path is sized such that the open working area is a large capacity working area capable of receiving a lumber workpiece having a height up to at least four feet and a width up to at least four feet.

14. The endless blade precision saw of claim 6, wherein the workpiece support surface comprises one or more generally horizontally oriented planar surfaces, and wherein the first and second spaced-apart support portions are generally vertically oriented.

15. The endless blade precision saw of claim 6, wherein a loaded workpiece is cuttable by the endless saw blade without clamping the workpiece to the workpiece support surface.

16. The endless blade precision saw of claim 6, wherein the blade has a thickness of approximately 0.063 inches.

17. The endless blade precision saw of claim 6, wherein the blade has a thickness not greater than approximately 0.100 inches.

18. The endless blade precision saw of claim 6, wherein the trim saw is operable in a third mode for vertically mitering lumber workpieces.

19. The endless blade precision saw of claim 18, wherein the endless saw blade support is rotatable about a vertical axis.

20. The endless blade precision saw of claim 6, wherein the trim saw is operable in a third mode for angularly mitering lumber workpieces.

21. A method for cutting a workpiece using a horizontal band saw machine, comprising:
providing a horizontal band saw machine having a single column construction comprising a single column positioned on a rear side of the band saw machine and a saw blade support arm movable along the single column, the band saw machine defining a workpiece loading region adjacent the single column;
feeding a workpiece into the workpiece loading region of the horizontal band saw machine;
driving an endless band saw blade about the saw blade support arm in a horizontal orientation and through a workpiece cutting region; and
cutting a workpiece positioned within the workpiece cutting region.

22. The method of claim 21, wherein prior to the endless band saw blade entering the workpiece cutting region, turning the band saw blade approximately ninety degrees such that a cutting plane of the band saw blade is in a vertical orientation when driven through the workpiece cutting region.

23. The method of claim 22, further comprising:
raising the saw blade support arm and the workpiece cutting region above the workpiece loading region; and
lowering the saw blade support arm relative to the workpiece loading region to position the workpiece within the workpiece cutting region to cut the workpiece.

24. The method of claim 21, wherein the endless band saw blade is driven through the workpiece cutting region in the horizontal orientation.

25. The method of claim 24, wherein feeding comprises feeding the workpiece into the workpiece cutting region to cut the workpiece.

26. The method of claim 24, wherein the horizontal band saw machine further comprises a movable carriage, wherein the saw blade support arm, band saw blade and single column are coupled to the movable carriage, the method further comprising moving the movable carriage to position the workpiece within the workpiece cutting region to cut the workpiece.

27. The method of claim 21, wherein feeding the workpiece comprises feeding the workpiece via one of a front, upstream or downstream side of the band saw machine, the front side being generally opposite the rear side of the band saw machine.

28. The method of claim 21, wherein the horizontal band saw machine further comprises a movable carriage, and wherein the saw blade support arm and single column are coupled to the movable carriage, the method further comprising moving the movable carriage to move the saw blade support arm and single column relative to the workpiece loading region.

29. The method of claim 28, further comprising moving the movable carriage to a position proximate an end portion of the workpiece, and lowering the band saw blade support arm to position the workpiece within the workpiece cutting region to cut the end portion off of the workpiece.

30. The method of claim 29, wherein the position comprises a first position and the end portion comprises a first end portion, the method further comprising moving the movable carriage from the first position proximate the first end portion of the workpiece to a second position intermediate the first end portion and a second end portion of the workpiece, and lowering the band saw blade support arm such that the driven band saw blade cuts through the workpiece at a location intermediate the first and second end portions of the workpiece.

31. The method of claim 28, wherein the saw blade support arm is lowered to cut the workpiece positioned in the workpiece loading region without clamping the workpiece.

32. The method of claim 21, wherein the single column is rotatable about a vertical axis, the method further comprising rotating the column, and wherein cutting the workpiece comprises mitering the workpiece.

33. The method of claim 21, wherein the endless band saw blade is driven through the workpiece cutting region in an angular orientation intermediate the horizontal orientation and a vertical orientation, the method further comprising vertically lowering the blade support arm and simultaneously horizontally moving the column to cut the workpiece positioned within the workpiece cutting region.
